(19) United States
(12) Patent Application Publication
(10) Pub. No.: US 2015/0178134 A1
(43) Pub. Date: Jun. 25, 2015

(54) Hybrid Crowdsourcing Platform

(71) Applicant: Peng Dai, Mountain View, CA (US)

(72) Inventor: Peng Dai, Mountain View, CA (US)

(73) Assignee: GOOGLE INC., Mountain View, CA (US)

(21) Appl. No.: 13/418,508

(22) Filed: Mar. 13, 2012

(51) Int. Cl. G06Q 10/06

(52) U.S. Cl. CPC G06F 9/50

(57) ABSTRACT

Systems and methods for implementing a hybrid crowdsourcing platform are provided. The hybrid crowdsourcing platform can receive a work request having a task with a plurality of units of work. One or more of the units of work can be suitable for completion by either a computer-based resource or a crowdsourcing resource. The individual units of work for the task can be analyzed to identify metrics associated with completion of the unit of work by the crowdsourcing resource and by the computer-based resource. Based on these metrics, the units of work can be assigned for completion by either the crowdsourcing resource or by the computer-based resource to improve the utility of the solution to the task.

### FIELD

The present disclosure relates generally to crowdsourcing, and more particularly to a hybrid crowdsourcing platform that can make use of both human and computing resources.

### BACKGROUND

Crowdsourcing has become increasingly used to outsource a variety of tasks, typically in the form of an open call, for completion by large groups of people. With the advance of the Internet, crowdsourcing services can provide online marketplaces where businesses and other entities can submit tasks for completion by thousands, if not millions, of workers online.

Many crowdsourced tasks, such as image labeling, natural language annotation, optical character recognition and other tasks, are challenging for solution by computing resources, but are relatively easy for humans. It is typically more efficient for these tasks to be crowdsourced to human workers for completion. However in certain cases, it can be more cost effective for tasks to be completed by computing resources. Advanced computer programs have been developed to address many tasks that are crowdsourced for completion by human workers. Indeed, human worker responses to crowdsourced tasks have been used to evaluate and/or further develop the advanced computer programs to improve the accuracy of the computer programs.

Typical crowdsourcing platforms do not assess whether a task is more suitable for completion by human or computing resources. As a result, businesses and other entities often submit tasks for completion by crowdsourcing resources that may be more suitable for completion by computing resources. Moreover, certain tasks may include many individual units of work, with some units of work being suitable for completion by a crowdsourcing resource and some units of work being suitable for completion by a computer-based resource. However, a typical platform will either submit all of the units of work for completion by a crowdsourcing resource or all of the units of work for completion by a computer-based resource, leading to inefficiency.

### SUMMARY

Aspects and advantages of the invention will be set forth in part in the following description, or may be obvious from the description, or may be learned through practice of the invention.

One exemplary aspect of the present disclosure is directed a computer-implemented method for providing a solution for a task. The method includes receiving a work request comprising at least one task having a plurality of units of work; and analyzing, with a computing device, at least one of the units of work to determine whether to assign the unit of work for completion by a computer-based resource or by a crowdsourcing resource.

Another exemplary aspect of the present disclosure is directed to a hybrid crowdsourcing platform. The platform includes a user interface for receiving a work request having at least one task that includes a plurality of units of work. One or more of the units of work are suitable for completion by a crowdsourcing resource or a computer-based resource. The platform includes a performance model associated with the task. The performance model provides metrics associated with completion of at least one of the plurality of units of work by the crowdsourcing resource and by the computer-based resource. The platform further includes a decision engine configured to assign at least one of the plurality of units of work for completion by the crowdsourcing resource or by the computer-based resource based on metrics associated with the unit of work provided by the performance model.

Other exemplary aspects of the present disclosure are directed to systems, apparatus, computer-readable media, and other devices for providing solutions to a task.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 depicts an overview of an exemplary system according to an exemplary embodiment of the present disclosure;

FIG. 2 depicts a flow diagram of an exemplary method according to an exemplary embodiment of the present disclosure;

FIG. 3 depicts a flow diagram of an exemplary method according to an exemplary embodiment of the present disclosure; and

FIG. 4 depicts a block diagram of an exemplary system according to an exemplary embodiment of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Generally, the present disclosure is directed to systems and methods that implement a hybrid crowdsourcing platform for providing a more optimal outcome for a task by choosing a suitable mechanism to complete each unit of work for the task. The system and method analyzes parameters associated with the individual units of work and determines metrics associated with completion of the unit of work by a crowdsourcing resource and by a computer-based resource. Based on these metrics, the units of work are assigned for completion by either the crowdsourcing resource or the computer-based resource to improve the utility of the solution to the task. The assignment of the tasks can be completely transparent to the business or other entity requesting a solution to the task. The hybrid crowdsourcing platform can be viewed as a black box that automatically completes the task by making remote procedure calls to either computer-based resources or crowdsourcing resources.

In one implementation, the metrics associated with completion of the individual units of work are determined from a performance model. The performance model captures the extent of difficulty for a task (e.g. measured in terms of accuracy), where the task is solved by either a crowdsourcing resource or by a computer based resource. The performance model can be based on parameters or intrinsic features associated with the task. Based on the parameters associated with a unit of work for the task, the performance model can provide metrics, such as accuracy estimates and/or costs estimates, for completion of the unit of work by either a crowdsourcing resource or by a computer-based resource.

According to particular aspects of the present disclosure, the performance model can be dynamically updated by a learning algorithm that monitors responses to the units of work by both crowdsourcing resources and computer-based resources. The learning algorithm can monitor the actual accuracy and cost of obtaining a response for the unit of work and update the performance model so that the performance model can provide more accurate metrics for later units of work in the task or for future related tasks.

The metrics provided by the performance model can be provided to a decision engine, which assigns the unit of work for completion by either a crowdsourcing resource or a computer-based resource based on the identified metrics for the unit of work. The unit of work can be assigned based on cost constraints, accuracy constraints, and/or to optimize a utility function associated with completion of the task.

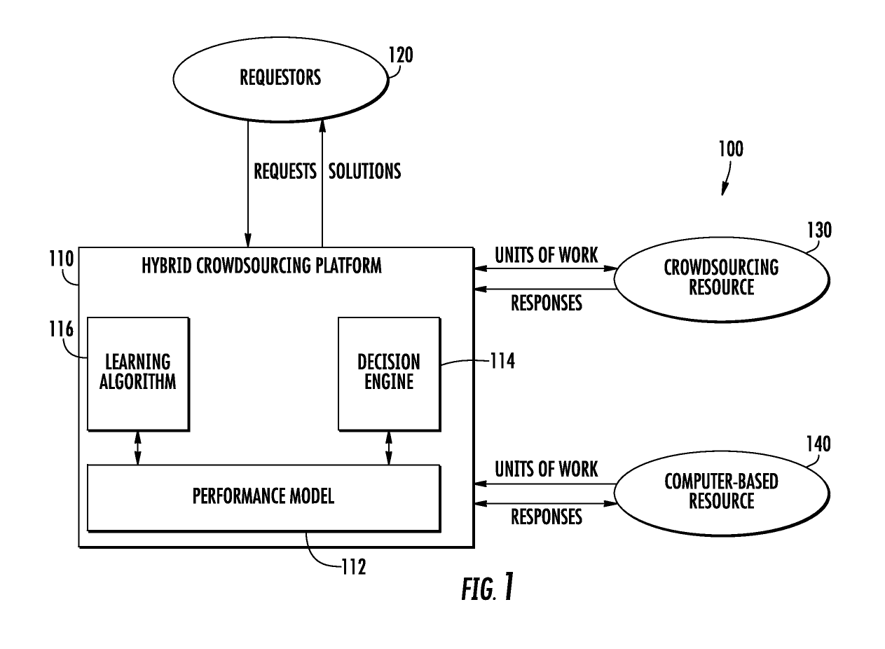

FIG. 1 depicts an overview of an exemplary hybrid crowdsourcing system 100 according to an exemplary aspect of the present disclosure. The hybrid crowdsourcing system 100 includes a hybrid crowdsourcing platform 110 that receives requests from businesses and other entities, collectively referred to as requestors 120, for tasks to be completed. The tasks can be provided to a crowdsourcing resource 130 or to a computer-based resource 140 for completion. The crowdsourcing resource 130 typically includes a large group of human participants that provide responses for the tasks pursuant to a typically open call for responses. The computer-based resource 140 can include a computer program executed by the processor of a computing device to complete the task.

Exemplary tasks can include annotating images, natural language annotation, optical character recognition, verifying data, data collection or compilation, translating passages and/or other materials, verifying search results, or other tasks. Those of ordinary skill in the art, using the disclosures provided herein, should understand that the present invention is not limited to any particular task or request.

A task can include a plurality of units of work that make up the task. The units of work are individual subsets of the task to which a worker or computational resource can provide a response. A task can include a single unit of work or many thousands of units of work depending on the nature of the task. For instance, a task directed to generating a logo for a new product could include a single unit of work-the design of the logo. A task directed to, for instance, annotating images, translating documents, and/or verifying search results can include many units of work. For instance, each image or other data that requires annotation can be considered a unit of work for the task.

The hybrid crowdsourcing platform 110 can provide individual units of work for the task to the computer based-resource 140 or to workers associated with crowdsourcing resource 130 for completion. The units of work can be provided in duplicate to achieve a desired accuracy level for the task. The workers and computer-based resources 140 can complete the task by providing responses to the units of work to the hybrid crowdsourcing platform 110. The responses can be logged at the crowdsourcing platform 110 and provided to the requestor 120. A reward or compensation can be provided to the workers for completing the units of work. The reward or compensation provides an incentive for the workers to complete the tasks.

As illustrated in FIG. 1, the hybrid crowdsourcing platform 110 includes a performance model 112, a decision engine 114, and a learning algorithm 116. The performance model 112 is developed to provide metrics associated with obtaining responses to a unit of work by either the crowdsourcing resource 130 or the computer based resource 140.

One type of metric that can be provided by the performance model can include an estimated accuracy for the response. For instance, the metrics can include a metric providing an estimated accuracy of obtaining a response to a unit of work by the crowdsourcing resource 130 and a metric providing an estimated accuracy of obtaining a response to a unit of work by the computer-based resource 140. The estimated accuracy for the crowdsourcing resource 130 can be based on an overall accuracy for the task or a related task of the crowdsourcing resources 130. In particular implementations, the estimated accuracy can take into account individual worker accuracies. For instance, if it can be determined that a particular worker or group of workers will be assigned a task, the estimated accuracy can be determined based on individual accuracies associated with the particular worker or group of workers. The estimated accuracy for the computer-based resource 130 can be based at least from testing and accuracy data associated with the computer-based resource 130.

Another type of metric can include estimated costs for obtaining the response. For instance, the metrics can include a metric providing a cost estimate of obtaining a response from the crowdsourcing resource 130 and a metric providing a cost estimate of obtaining a response from the computer-based resource. The cost estimate for obtaining the response from the crowdsourcing resource can be based on the reward or compensation to workers for providing a response to the unit of work. The cost estimate can also take into account the estimated time for obtaining the response from the workers. The cost estimate for the computer-based resource can be based on the number of computational resources necessary to provide a response to the unit of work, as well as the processing time.

Other metrics that can be used in assigning units of work for completion by a computer-based resource or by a crowdsourcing resource can be provided from the performance model without deviating from the scope of the present disclosure. For instance, the metrics can include an estimated time for obtaining a response, estimated difficulty of obtaining the response, and other suitable metrics.

The performance model 112 can provide metrics as a function of an intrinsic feature associated with the unit of work for the task. In particular, each of the units of work for a task can have an associated parameter that can be used to determine metrics for the unit of work. The parameter of the unit of work can be indicative of the accuracy and the cost of obtaining responses to the unit of work by the computer-based resource and by the crowdsourcing resource and can be based on for instance, the number of steps required to provide a response to the unit of work. In the example of a natural language annotation task, the parameter could include the length of text. In the example of an image annotation task, the parameter could include the number of objects in the image. In the example of a translation task, the parameter could include the length and/or complexity of text that needs translating.

According to a particular aspect of the present disclosure, the performance model 112 can be dynamically updated based on responses received to the units of work. For instance, the learning algorithm 116 can monitor responses to units of work as they are received from either the crowdsourcing resource 130 or the computer-based resource 140. The learning algorithm 116 can assess the actual accuracy, cost, or other metric associated with the response. Based on this information, the learning algorithm 116 can update the performance model 112 to provide more accurate metrics. In this manner, the performance model 112 can be continuously improved as the hybrid crowdsourcing receives responses to units of work from either the crowdsourcing resource 130 or the computer-based resource 140.

The decision engine 114 receives the metrics for the unit of work from the performance model 112 and assigns the individual units of work based on the metrics for completion by the crowdsourcing resource 130 or by the computer-based resource 140. In one example, the decision engine 114 can assign the unit of work to meet specified cost constraints. In another example, the decision engine 114 can assign the unit of work to meet specified accuracy constraints. In yet another example, the decision engine 114 can assign the unit of work based on a utility function associated with the task. The utility function can provide a measure of the usefulness or utility of the response based on the accuracy, cost, and/or other metrics associated with obtaining a response to the unit of work.

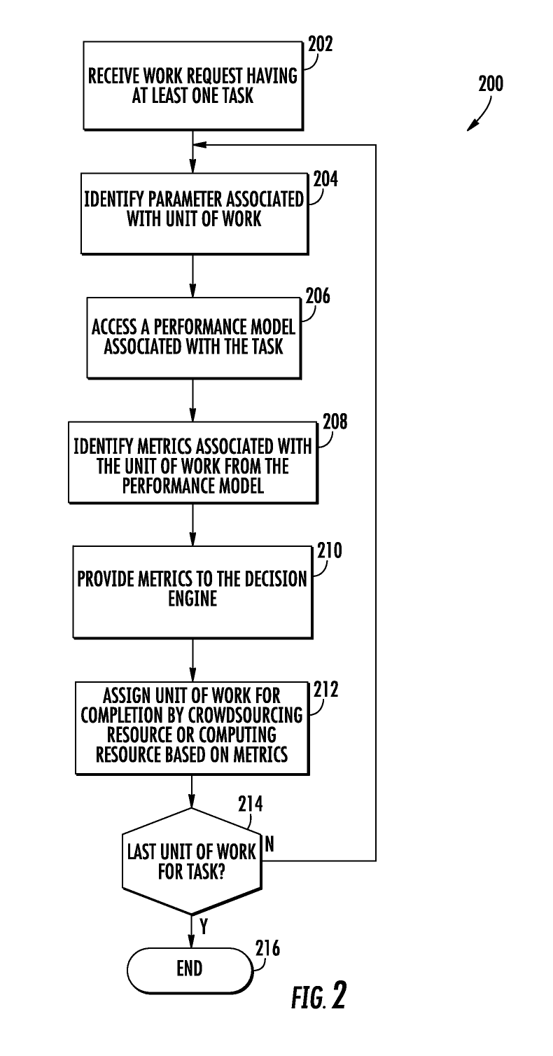

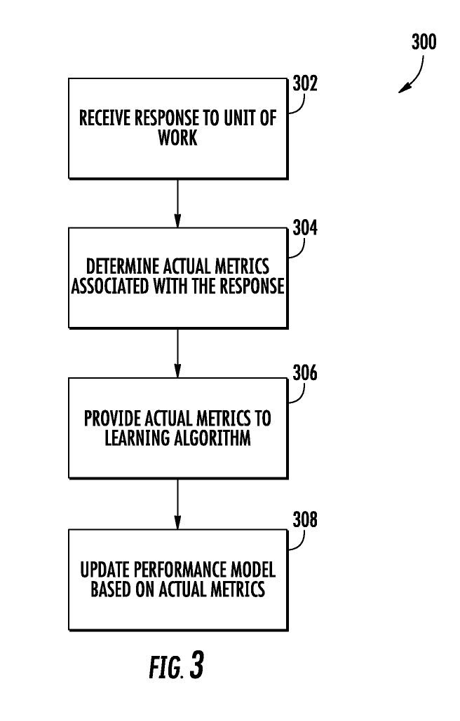

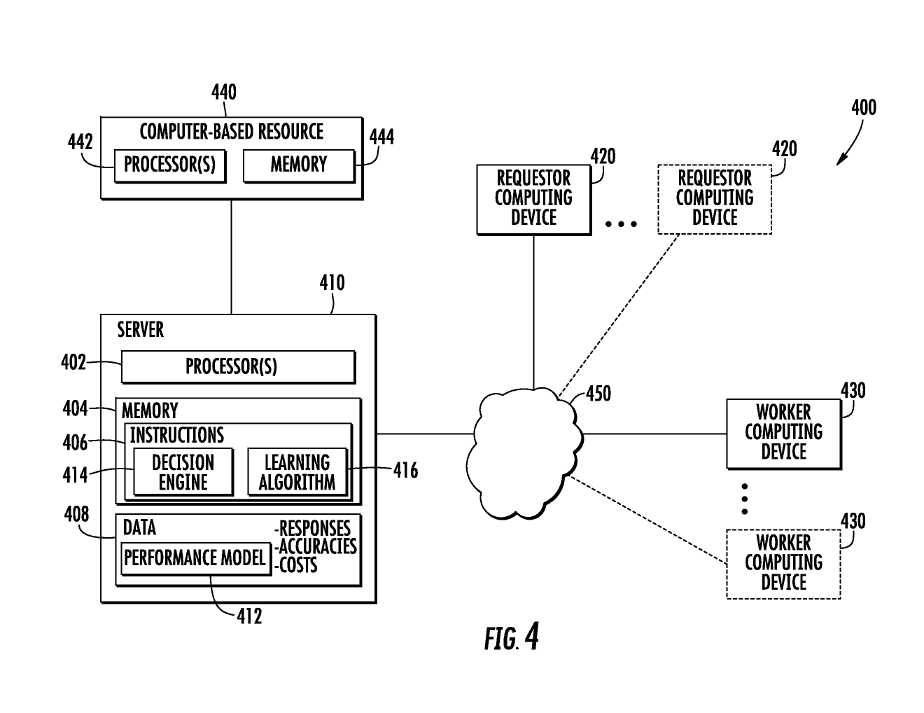

With reference now to FIGS. 2-3, exemplary methods for implementing a hybrid crowdsourcing platform will be discussed in detail. The methods will be discussed with reference to the hybrid crowdsourcing platform depicted in FIG. 1 and can be implemented by any computing-based system. An exemplary computer-based system for implementing the methods will be discussed with reference to FIG. 4 below. In addition, although FIGS. 2-3 depict steps performed in a particular order for purposes of illustration and discussion, the methods discussed herein are not limited to any particular order or arrangement. One skilled in the art, using the disclosures provided herein, will appreciate that various steps of the methods can be omitted, rearranged, combined and/or adapted in various ways.

FIG. 2 depicts an exemplary method 200 for assigning units of work for completion by a crowdsourcing resource or by a computer-based resource. At (202) the method includes receiving a work request comprising at least one task. For instance, a requestor 120 can submit a work request to the hybrid crowdsourcing platform 110 asking the hybrid crowdsourcing platform 110 to obtain a solution for the task. The task can include image labeling, natural language annotation, optical character recognition translation, or other suitable task. The task can include a plurality of units of work. The method 200 will perform an analysis of each of the units of work and assign each of those units of work for completion by either a crowdsourcing resource or the computer-based resource to provide a more optimum solution for the task.

In particular, for each unit of work in the task, parameters associated with the unit of work are identified (204). For instance, the hybrid crowdsourcing platform 110 can analyze the unit of work to identify at least one parameter associated with the unit of work. In one embodiment, the parameter can be representative of the number of steps that must be taken to provide a response to the unit of work. For instance, the parameter can include information such as the length of text in a natural annotation task or translation task, the number of objects in an image annotation task, the number and/or type of characters in an optical character recognition task, or other suitable parameter.

Any suitable technique can be used for identifying the parameter of the unit of work. For instance, a word or character count algorithm can be used to identify the length of text or number of characters for a unit of work. Image processing techniques can be used to identify the number of objects that require annotation. In a particular implementation, the parameter can be identified based on settings associated with the request provided from the requestor 120. For instance, in submitting the work request, the requestor 120 can provide information associated with the tasks, such as information concerning the complexity and difficulty of the task. This information can be used in identifying parameters for the individual units of work.

Once the parameter for a unit of work has been identified, a performance model, such as performance model 112, associated with the task can be accessed (206) so that metrics associated with completion of the unit of work by either a crowdsourcing resource or by a computer-based resource can be identified (208). The performance model can provide the metrics as a function of the identified parameter of the unit of work. The metrics can include estimated accuracy, estimated cost, and other suitable metrics associated with completion of the unit of work by a crowdsourcing resource and by a computer-based resource.

Once the metrics are identified, the metrics can be provided to the decision engine (210) so that the unit of work can be assigned for completion by either a crowdsourcing resource or a computer-based resource (212). For instance, the decision engine 114 can receive the metrics from the performance model and assign the unit of work for completion by either the crowdsourcing resource 130 or the computer-based resource 140 based on metrics provided from the performance model 112.

The decision engine 114 can use any suitable technique to assign the unit of work based on the identified metrics. In one example, the decision engine 114 can assign the unit of work based on cost constraints. For instance, a requestor 120 can provide a cost constraint, such as a budget, along with the work request. The decision engine 114 can receive metrics that include cost estimates from the performance model based on a parameter associated with the unit of work. The decision engine 114 can then assign the unit of work for completion by the crowdsourcing resource 130 or the computer-based resource 140 such that the total cost for completing the task does not exceed the cost constraints.

In another example, the decision engine 114 can assign the unit of work for completion based on accuracy constraints. For instance, a requestor 120 can provide an accuracy constraint, such as 95% accuracy or any other accuracy, along with the work request. The decision engine 114 can receive metrics including accuracy estimates from the performance model based on a parameter associated with the unit of work. The decision engine 114 can then assign the unit of work for completion by the crowdsourcing resource 130 or the computer-based resource 140 such that the total accuracy for completing the task falls within the accuracy constraints.

In yet another example, the decision engine 114 can assign the unit of work for completion based on a combination of both accuracy constraints and cost constraints. For instance, the decision engine 114 can assign the unit of work for completion by the most accurate resource so long as cost constraints are not exceeded. Alternatively, the decision engine 112 can assign the unit of work for completion by the most cost effective resource so long as accuracy constraints are satisfied.

In yet another example, the decision engine 114 can assign the unit of work for completion based on a utility function associated with the task. The utility function can provide a measure of the utility of a response to a unit of work (or to a collection of units of work for the task) as a function of various metrics associated with responses to the units of work, such as the accuracy and cost for obtaining a response to the unit of work. The utility function can be provided by the requestor 120 or can be generated by the hybrid crowdsourcing platform 110.

For instance, in one embodiment the requestor 120 can input settings associated with the importance of accuracy, cost, time and/or other factors in obtaining a solution for a task. This information can be used to generate a utility function for the task. The utility function can be a function of a single variable or multiple variables, including one or more of accuracy, cost and/or other metrics. Weights can be assigned to the variables in the utility function based on the settings input by the requestor 120. The decision engine 114 can then assign units of work to either the crowdsourcing resource 130 or the computer-based resource 140 in a manner that optimizes the utility function. In this manner, the hybrid crowdsourcing platform 110 can assign units of work to achieve more cost effective and accurate solutions for the task.

Once the unit of work has been assigned, the method determines whether the unit of work was the last unit of work for the task (214). If the unit of work was the last unit of work, the method terminates (216). If the unit of work is not the last unit of work, the method is repeated for each unit of work in the task until all units of work have been assigned for completion by a crowdsourcing resource or a computer-based resource.

FIG. 3 depicts an exemplary method for dynamically updating the performance model according to a particular embodiment of the present disclosure. At (302) a response to a unit of work is received. For instance, after one or more units of work have been assigned for completion by the crowdsourcing resource 130 or by the computer based resource 140, responses to the one or more units of work can be received at the hybrid crowdsourcing platform 110.

These responses are analyzed at (304) to determine actual metrics associated with obtaining the response. For instance, if the unit of work was assigned to a crowdsourcing resource, the actual metric can include the actual cost and accuracy associated with obtaining the response from the crowdsourcing resource. If the unit of work was assigned to a computer-based resource, the actual metric can include the actual cost and accuracy associated with obtaining the response from computer-based resource.

At (306), the actual metrics are provided to a learning algorithm, such as learning algorithm 116, which analyzes the responses and actual metrics and updates the performance model based on the actual metrics (308). For instance, the learning algorithm 116 can compare the actual metrics to the estimated metrics provided by the performance model 112. If the difference between the actual metrics and the estimated metrics exceeds a threshold, the learning algorithm 116 can adjust the performance model so that the estimated metrics fall more in line with the actual metrics for the unit of work. In this manner, the hybrid crowdsourcing platform 110 can more effectively assign units of work for completion by either the crowdsourcing resource 130 or the computer-based resource 140 by developing a more accurate and useful performance model 112.

Referring now to FIG. 4, an exemplary system 400 for implementing the methods and platforms discussed herein according to an exemplary embodiment of the present disclosure will be discussed in detail. Crowdsourcing system 400 includes a computing device 410 that can be coupled to one or more requestor computing devices 420 and worker computing devices 430 over a network 450. The network 450 can include a combination of networks, such as cellular network, WiFi network, LAN, WAN, the Internet, and/or other suitable network and can include any number of wired or wireless communication links. The system 400 further includes a computer-based resource 440 that can be coupled to communicating device 410 over network 450 or any other suitable interface.

Computing device 410 can be a server, such as a web server, that exchanges information, including various tasks for completion, with requestor computing devices 420 and worker computing devices 430 over network 450. For instance, requestors can provide information, such as requests for tasks to be completed, from computing devices 420 to computing device 410 over network 450. Workers can provide responses to the tasks from computing devices 430 to computing device 410 over network 450. The computing device 410 can then track or maintain an appropriate reward or compensation for the workers for completing the task.

The requestor computing devices 420 and the worker computing devices 430 can take any appropriate form, such as a personal computer, smartphone, desktop, laptop, PDA, tablet, or other computing device. The requestor computing devices 420 and the worker computing devices 430 can include a processor and a memory and can also include appropriate input and output devices, such as a display screen, touch screen, touch pad, data entry keys, speakers, and/or a microphone suitable for voice recognition.

Similar to requestor computing devices 420 and worker computing devices 430, computing device 410 can include a processor(s) 402 and a memory 404. The processor(s) 402 can be any known processing device. Memory 404 can include any suitable computer-readable medium or media, including, but not limited to, RAM, ROM, hard drives, flash drives, or other memory devices. Memory 404 stores information accessible by processor(s) 402, including instructions 406 that can be executed by processor(s) 402. The instructions 406 can be any set of instructions that when executed by the processor(s) 402, cause the processor(s) 402 to provide desired functionality.

For instance, the instructions 406 can specify a decision engine 414 that analyzes metrics received from a performance model 412 stored in memory 404 to assign units of work for completion to workers or to computer-based resource 440. The instructions could further specify a learning algorithm 416 that can be used to dynamically update the performance model 412 based on responses received from the worker computing devices 430 and the computer-based resource 440.

The instructions 406 can be software instructions rendered in a computer-readable form. When software is used, any suitable programming, scripting, or other type of language or combinations of languages may be used to implement the teachings contained herein. Alternatively, the instructions can be implemented by hard-wired logic or other circuitry, including, but not limited to application-specific circuits.

Memory 404 can also include data 408 that may be retrieved, manipulated, or stored by processor(s) 402. For instance, memory 404 can store information associated with tasks, units of work, responses, accuracies, costs and other information. Memory 404 can also store the performance model 412, which can be used to provide metrics based on a parameter associated with a unit of work.

Computer-based resource 440 can be any computing device, or can alternatively be a part of or integrated with computing device 410. Computer-based resource 440 can include a processor 442 and a memory 444. The processor 442 can execute instructions in the form of a computer program stored in the memory 444 to provide responses to units of work provided to the computer-based resource 440 from the computing device 410.

The computing device 410 can communicate information to requestor computing devices 420, worker computing devices 430, and computer-based resource 440 in any suitable format. For instance, the information can include HTML code, XML messages, WAP code, Java applets, xhtml, plain text, voiceXML, VoxML, VXML, or other suitable format.

While FIG. 4 illustrates one example of a computer-based system 400 that can be used to implement the methods of the present disclosure, those of ordinary skill in the art, using the disclosures provided herein, will recognize that the inherent flexibility of computer-based systems allows for a great variety of possible configurations, combinations, and divisions of tasks and functionality between and among the components. For instance, the computer-implemented methods discussed herein may be implemented using a single server or processor or multiple such elements working in combination. Databases and other memory/media elements and applications may be implemented on a single system or distributed across multiple systems.

While the present subject matter has been described in detail with respect to specific exemplary embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

1. A computer-implemented method for providing a solution for a task, comprising:
receiving, by one or more computing devices, a work request comprising at least one task having a unit of work;
identifying, by one or more computing devices, a parameter associated with the unit of work;
analyzing, by one or more computing devices, the parameter associated with the unit of work to identify a first metric associated with the completion of the unit of work by a crowdsourcing resource and to identify a second metric associated with the completion of the unit of work by a computer-based resource, and
selecting, by one or more computing devices, between the crowdsourcing resource and the computer-based resource for completion of the unit of work using a utility function providing a measure of the utility of a response by the crowdsourcing resource and the computer-based resource based at least in part on the first and second metrics.

2. The computer-implemented method of claim 1, wherein the first metric comprises an accuracy estimate associated with completion of the unit of work by the crowdsourcing resource and the second metric comprises an accuracy estimate associated with completion of the unit of work by the computer-based resource.

3. The computer-implemented method of claim 1, wherein the first metric comprises a cost estimate associated with completion of the unit of work by the crowdsourcing resource and the second metric comprises a cost estimate associated with completion of the unit of work by the computer-based resource.

4. The computer-implemented method of claim 1, wherein analyzing the parameter associated with the unit of work to identify the first and second metrics comprises accessing a performance model associated with the at least one task, the performance model providing the first and second metrics based on the parameter associated with the unit of work.

5. The computer-implemented method of claim 4, wherein the method comprises dynamically updating the performance model based on a response to the unit of work.

6. (canceled)

7. The computer-implemented method of claim 1, wherein the method comprises receiving a cost constraint for the task, the unit of work being assigned for completion by the crowdsourcing resource or by the computer-based resource based on the cost constraint.

8. The computer-implemented method of claim 1, wherein the method comprises receiving an accuracy constraint for the task, the unit of work being assigned for completion by the crowdsourcing resource or by the computer-based resource based on the accuracy constraint.

9. The computer-implemented method of claim 1, wherein the crowdsourcing resource comprises one or more human workers.

10. The computer-implemented method of claim 1, wherein the computer-based resource comprises a computer program executed by a processor of a computing device.

11. A hybrid crowdsourcing platform, comprising:
a computing device having a processor and a memory, the computing device comprising an interface for receiving a work request, the work request comprising at least one task having a unit of work, the unit of work being suitable for completion by either a crowdsourcing resource or a computer-based resource;
the memory storing a performance model associated with the task, the performance model providing metrics associated with completion of the unit of work by the crowdsourcing resource and by the computer-based resource, the performance model providing the metrics based on a parameter associated with the unit of work; and
the processor configured to execute computer-readable instructions stored in the memory to implement a decision engine, the decision engine configured to select between the crowdsourcing resource and the computer-based resource for completion of the unit of work using utility function providing a measure of the utility of a response by the crowdsourcing resource and the computer-based resource based on metrics associated with the unit of work provided by the performance model.

12. The hybrid crowdsourcing platform of claim 11, wherein the metrics comprise accuracy estimates for completion of the unit of work by the crowdsourcing resource and by the computer-based resource.

13. The hybrid crowdsourcing platform of claim 11, wherein the metrics comprise cost estimates for completion of the unit of work by the crowdsourcing resource and by the computer-based resource.

14. (canceled)

15. The hybrid crowdsourcing platform of claim 11, wherein the processor is configured to execute computer-readable instructions to implement a learning algorithm, the learning algorithm configured to dynamically update the performance model based on a response provided to the unit of work.

16. The hybrid crowdsourcing platform of claim 11, wherein the decision engine is configured to assign a unit of work for completion by either a crowdsourcing resource or by a computer-based resource based on a cost constraint, an accuracy constraint, or a utility function associated with the task.

17. A system for providing a solution for a task, the system comprising:
a first computing device configured to receive a work request from a second computing device over a network, the work request comprising at least one task having a unit of work, the unit of work being suitable for completion by either a crowdsourcing resource or by a computer-based resource;
the first computing device comprising a processing device configured to execute computer-readable instructions stored in a memory to analyze a parameter associated with the unit of work and to select between the crowdsourcing resource and the computer-based resource for completion of the unit of work based on a performance model providing metrics associated with the completion of the unit of work by the crowdsourcing resource and the computer-based resource, the performance model providing the metrics for the unit of work as a function of the parameter associated with the unit of work;
the first computing device configured to provide a response to the unit of work to the second computing device over the network.

18. (canceled)

19. The system of claim 17, wherein the processing device is configured to dynamically update the performance model based on a response provided to the unit of work.

20. The system of claim 19, wherein the processing device is configured to dynamically update the performance model based on the accuracy or the cost of the response provided to the unit of work.
